(19) United States
(12) Patent Application Publication
(10) Pub. No.: US 2021/0123358 A1
(43) Pub. Date: Apr. 29, 2021

(54) SPLINE SEAL FOR DISK POST

(71) Applicant: General Electric Company, Schenectady, NY (US)

(72) Inventors: Steven Douglas Johnson, Milford, OH (US); Robert Proctor, Mason, OH (US)

(21) Appl. No.: 16/666,561

(22) Filed: Oct. 29, 2019

(51) Int. Cl. F01D 11/00

(52) U.S. Cl. CPC F01D 11/005; F05D 2240/55

(57) ABSTRACT

An airfoil assembly and method for an engine comprising a plurality of circumferentially arranged platforms having confronting end faces each platform defining a base portion from which an airfoil extends outwardly defining a radial direction and from which a set of legs extends radially inward, a disk post coupled to at least one leg of the set of legs, a cavity formed by the platform, set of legs, and the disk post defining a static pressure zone during operation, a high pressure zone located exteriorly of the cavity; and at least one blocking spline seal.

### TECHNICAL FIELD

The disclosure generally relates to a seal in an engine, specifically a spline seal located in a platform for a turbine blade assembly.

### BACKGROUND

Turbine engines, particularly gas turbine engines, are rotary engines that extract energy from a flow of combusted gases passing through the engine onto a multitude of rotating turbine blades as a hot gas flow. Controlling airflow and leakage is important to engine efficiency Eliminating, decreasing, or changing gas flow paths adjacent and through segmented turbine engine assembly is necessary to achieve control of where and how much cooling in the engine takes place. Cooling within the engine is important, preventing the hot gas flow from mixing with cooling fluids or contacting cooling areas enables higher efficiency.

### BRIEF DESCRIPTION

In one aspect, the present disclosure relates to an airfoil assembly for an engine comprising: a plurality of circumferentially arranged platforms having confronting end faces each platform defining a base portion from which an airfoil extends outwardly defining a radial direction and from which a set of legs extends radially inward; a disk post coupled to at least one leg of the set of legs; a cavity formed by the platform, set of legs, and the disk post defining a static pressure zone during operation; a high pressure zone located exteriorly of the cavity; and at least one blocking spline seal located within the confronting end faces and extending from the base portion to the set of legs across a direct path between the high pressure zone and the static pressure zone.

In another aspect the present disclosure relates to a method of blocking a hot gas ingestion flow path between a high pressure zone located exteriorly of a platform for an airfoil assembly of an engine and a static pressure zone defined by a cavity formed radially inward of the platform, the method comprising: extending a blocking spline seal across the hot ingestion flow path where a portion of the blocking spline seal extends radially along a set of legs of the platform and a portion of the blocking spline seal extends axially along a base portion of the platform.

### DRAWINGS

In the drawings:

FIG. 1 is a schematic cross-sectional diagram of a turbine engine for an aircraft.

FIG. 2 is an enlarged side view of a portion of a turbine blade assembly having a platform and including a spline seal in the platform.

FIG. 3 is the same as FIG. 2 illustrating a pressure differential and a hot gas ingestion flow path.

FIG. 4 is an enlarged side view of a portion of a turbine blade assembly having a platform and including a spline seal in the platform according to another aspect of the disclosure herein.

FIG. 5 is an enlarged side view of a portion of a turbine blade assembly having a platform and including a spline seal in the platform according to yet another aspect of the disclosure herein.

### DESCRIPTION

Aspects of the disclosure described herein are directed to a spline seal located in a forward portion of a platform for a turbine blade assembly. For purposes of illustration, the present disclosure will be described with respect to a turbine blade assembly for an aircraft turbine engine. It will be understood, however, that aspects of the disclosure described herein are not so limited and may have general applicability within an engine, including compressors, as well as in non-aircraft applications, such as other mobile applications and non-mobile industrial, commercial, and residential applications.

As used herein, the term “forward” or “upstream” refers to moving in a direction toward the engine inlet, or a component being relatively closer to the engine inlet as compared to another component. The term “aft” or “downstream” used in conjunction with “forward” or “upstream” refers to a direction toward the rear or outlet of the engine or being relatively closer to the engine outlet as compared to another component. Additionally, as used herein, the terms “radial” or “radially” refer to a dimension extending between a center longitudinal axis of the engine and an outer engine circumference. Furthermore, as used herein, the term “set” or a “set” of elements can be any number of elements, including only one.

All directional references (e.g., radial, axial, proximal, distal, upper, lower, upward, downward, left, right, lateral, front, back, top, bottom, above, below, vertical, horizontal, clockwise, counterclockwise, upstream, downstream, forward, aft, etc.) are only used for identification purposes to aid the reader's understanding of the present disclosure, and do not create limitations, particularly as to the position, orientation, or use of aspects of the disclosure described herein. Connection references (e.g., attached, coupled, connected, and joined) are to be construed broadly and can include intermediate members between a collection of elements and relative movement between elements unless otherwise indicated. As such, connection references do not necessarily infer that two elements are directly connected and in fixed relation to one another. The exemplary drawings are for purposes of illustration only and the dimensions, positions, order and relative sizes reflected in the drawings attached hereto can vary.

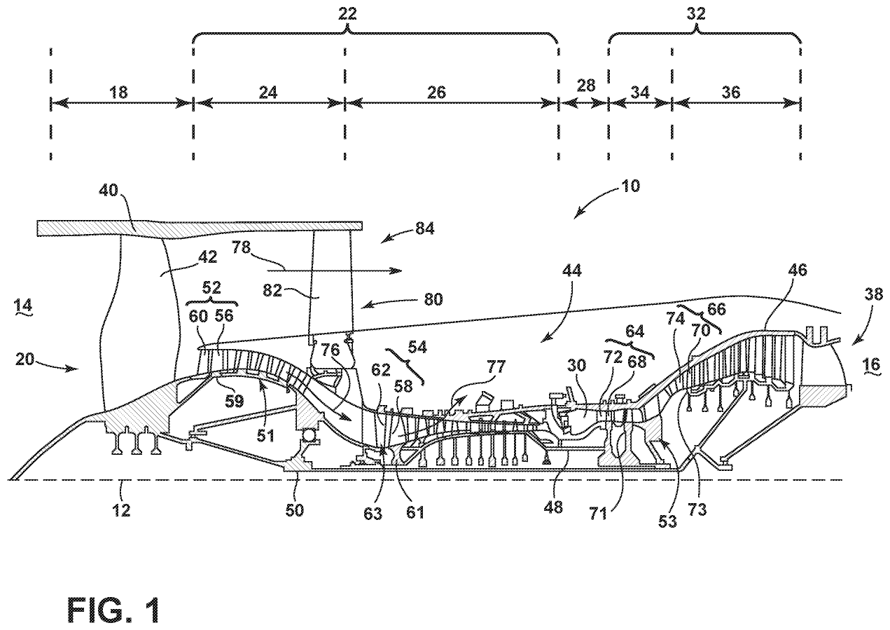

FIG. 1 is a schematic cross-sectional diagram of a gas turbine engine 10 for an aircraft. The engine 10 has a generally longitudinally extending axis or centerline 12 extending forward 14 to aft 16. The engine 10 includes, in downstream serial flow relationship, a fan section 18 including a fan 20, a compressor section 22 including a booster or low pressure (LP) compressor 24 and a high pressure (HP) compressor 26, a combustion section 28 including a combustor 30, a turbine section 32 including a HP turbine 34, and a LP turbine 36, and an exhaust section 38.

The fan section 18 includes a fan casing 40 surrounding the fan 20. The fan 20 includes a plurality of fan blades 42 disposed radially about the centerline 12. The HP compressor 26, the combustor 30, and the HP turbine 34 form a core 44 of the engine 10, which generates combustion gases. The core 44 is surrounded by core casing 46, which can be coupled with the fan casing 40.

A HP shaft or spool 48 disposed coaxially about the centerline 12 of the engine 10 drivingly connects the HP turbine 34 to the HP compressor 26. A LP shaft or spool 50, which is disposed coaxially about the centerline 12 of the engine 10 within the larger diameter annular HP spool 48, drivingly connects the LP turbine 36 to the LP compressor 24 and fan 20. The spools 48, 50 are rotatable about the engine centerline and couple to a plurality of rotatable elements, which can collectively define a rotor 51.

The LP compressor 24 and the HP compressor 26 respectively include a plurality of compressor stages 52, 54, in which a set of compressor blades 56, 58 rotate relative to a corresponding set of static compressor vanes 60, 62 to compress or pressurize the stream of fluid passing through the stage. In a single compressor stage 52, 54, multiple compressor blades 56, 58 can be provided in a ring and can extend radially outwardly relative to the centerline 12, from a blade platform to a blade tip, while the corresponding static compressor vanes 60, 62 are positioned upstream of and adjacent to the rotating blades 56, 58. It is noted that the number of blades, vanes, and compressor stages shown in FIG. 1 were selected for illustrative purposes only, and that other numbers are possible.

The blades 56, 58 for a stage of the compressor can be mounted to (or integral to) a disk 61, which is mounted to the corresponding one of the HP and LP spools 48, 50. The vanes 60, 62 for a stage of the compressor can be mounted to the core casing 46 in a circumferential arrangement.

The HP turbine 34 and the LP turbine 36 respectively include a plurality of turbine stages 64, 66, in which a set of turbine blades 68, 70 are rotated relative to a corresponding set of static turbine vanes 72, 74 (also called a nozzle) to extract energy from the stream of fluid passing through the stage. In a single turbine stage 64, 66, multiple turbine blades 68, 70 can be provided in a ring and can extend radially outwardly relative to the centerline 12 while the corresponding static turbine vanes 72, 74 are positioned upstream of and adjacent to the rotating blades 68, 70. It is noted that the number of blades, vanes, and turbine stages shown in FIG. 1 were selected for illustrative purposes only, and that other numbers are possible.

The blades 68, 70 for a stage of the turbine can be mounted to a disk 71, which is mounted to the corresponding one of the HP and LP spools 48, 50. The vanes 72, 74 for a stage of the compressor can be mounted to the core casing 46 in a circumferential arrangement.

Complementary to the rotor portion, the stationary portions of the engine 10, such as the static vanes 60, 62, 72, 74 among the compressor and turbine section 22, 32 are also referred to individually or collectively as a stator 63. As such, the stator 63 can refer to the combination of non-rotating elements throughout the engine 10.

In operation, the airflow exiting the fan section 18 is split such that a portion of the airflow is channeled into the LP compressor 24, which then supplies pressurized air 76 to the HP compressor 26, which further pressurizes the air. The pressurized air 76 from the HP compressor 26 is mixed with fuel in the combustor 30 and ignited, thereby generating combustion gases. Some work is extracted from these gases by the HP turbine 34, which drives the HP compressor 26. The combustion gases are discharged into the LP turbine 36, which extracts additional work to drive the LP compressor 24, and the exhaust gas is ultimately discharged from the engine 10 via the exhaust section 38. The driving of the LP turbine 36 drives the LP spool 50 to rotate the fan 20 and the LP compressor 24.

A portion of the pressurized airflow 76 can be drawn from the compressor section 22 as bleed air 77. The bleed air 77 can be drawn from the pressurized airflow 76 and provided to engine components requiring cooling. The temperature of pressurized airflow 76 entering the combustor 30 is significantly increased. As such, cooling provided by the bleed air 77 is necessary for operating of such engine components in the heightened temperature environments.

A remaining portion of the airflow 78 bypasses the LP compressor 24 and engine core 44 and exits the engine assembly 10 through a stationary vane row, and more particularly an outlet guide vane assembly 80, comprising a plurality of airfoil guide vanes 82, at the fan exhaust side 84. More specifically, a circumferential row of radially extending airfoil guide vanes 82 are utilized adjacent the fan section 18 to exert some directional control of the airflow 78.

Some of the air supplied by the fan 20 can bypass the engine core 44 and be used for cooling of portions, especially hot portions, of the engine 10, and/or used to cool or power other aspects of the aircraft. In the context of a turbine engine, the hot portions of the engine are normally downstream of the combustor 30, especially the turbine section 32, with the HP turbine 34 being the hottest portion as it is directly downstream of the combustion section 28. Other sources of cooling fluid can be, but are not limited to, fluid discharged from the LP compressor 24 or the HP compressor 26.

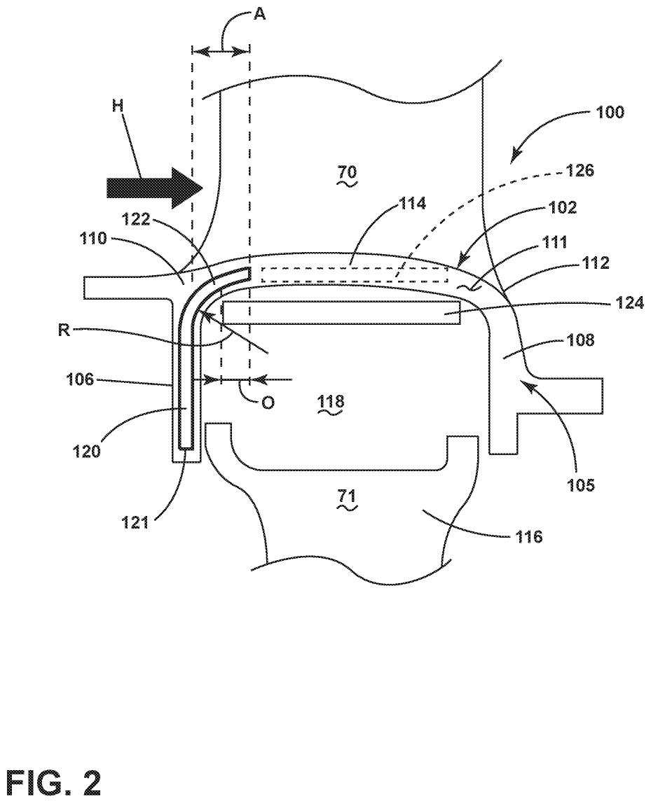

FIG. 2 is an enlarged side view of a portion of a turbine blade assembly 100 including one of the turbine blades 70. The turbine blade assembly 100 includes a platform 102, upon which the turbine blade 70 is mounted. The platform 102 can extend axially between a set of legs 105 comprising first and second leg portions 106, 108. The platform 102 can include forward and aft portions 110, 112, by way of non-limiting example having a curved shape and connecting a base portion 114 of the platform 102 to the first and second leg portions 106, 108 of the platform 102. A hot gas flow (H) travels in a generally axial direction from the first leg portion 106 toward the second leg portion 108 along the turbine blade 70. The platform can be one of many circumferentially arranged platforms within the engine, each platform defining circumferential confronting end faces 111.

A disk post 116 defining an edge of, by way of non-limiting example, the turbine rotor disk 71 is coupled radially below the platform 102 to each or both of the first and second leg portions 106, 108. It should be understood that the disk post 116 can be one of many disk posts circumferentially arranged about and extending radially from the rotor disk. The platform 102 and disk post 116 together can define a cavity 118 radially inward of the turbine blade 70.

A blocking spline seal 120 can be located in at least one of the confronting end faces 111, and more particularly within the first leg 106 forward of the cavity 118. At least one of the confronting end faces 111 can include a confronting seal channel 121 in which the blocking spline seal 120 is received. The blocking spline seal 120 can extend radially within the set of legs and extend axially within the axial portion to define a transition therebetween from a substantially axial direction to a substantially radial direction. It should be understood that substantially is within 0-5% of a perfectly axial and perfectly radial direction which are 90 degrees to each other. The transition can be, by way of non-limiting example, a curved feature 122 extending along the forward curved portion 110 and into the base portion 114 of the platform 102. A constant radius (R) can define at least a portion of the curved feature 122. The axial extent (A) to which the curved feature 122 of the blocking spline seal 120 extends into the base portion 114 can vary from not at all to the entire extent of the base portion 114. The turbine blade assembly 100 can be arranged circumferentially where in one aspect a plurality of spline seals 120 can be located between sequential blade assemblies.

Optionally a damper seal 124 can be coupled to the platform 102 within the cavity 118 and overlap with the curved feature 122 of the blocking spline seal 120. The overlapping extent (O) of the curved feature 122 and the damper seal 124 can vary from not at all to the entire extent of the damper seal 124. Optionally, an additional axial spline seal 126 can be located within the base portion 114 of the platform 102.

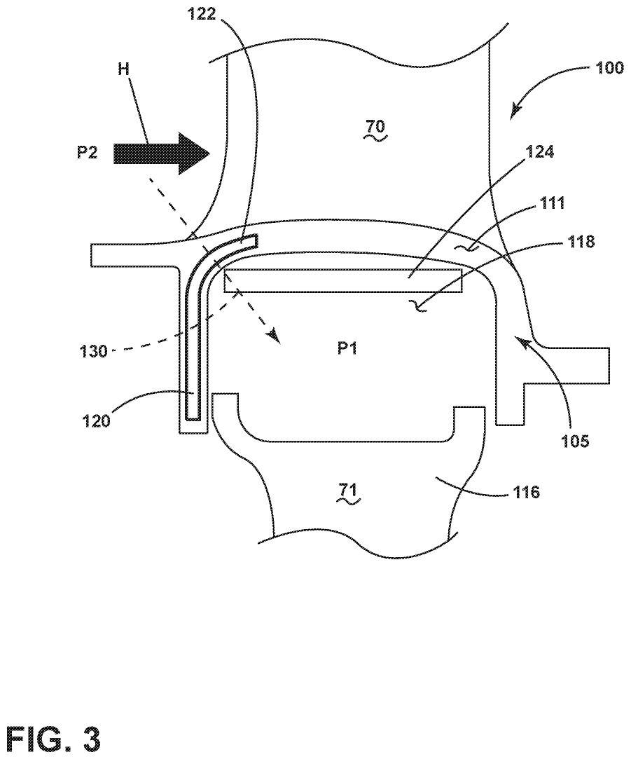

Turning to FIG. 3, the same side view is illustrated as FIG. 2 with some numbers omitted for clarity. The cavity 118 develops a static pressure P1 that is less than an exterior pressure P2 relative to the cavity 118 where the hot gas flow (H) is moving. This pressure differential can cause hot gas flow ingestion along a hot gas ingestion flow path 130 illustrated in dashed line. The vector of the hot gas ingestion flow path 130 can impinge on the disk post 116 causing increased temperatures of the disk post and in turn a shorter lifespan for the disk post 116. Locating the blocking spline seal 120 with the curved feature 122 in the platform 102 and extending the spline axially into the horizontal, or base portion 114 of the platform 102, such that it axially overlaps a horizontal blade damper seal 124, as described herein, can minimize this hot gas ingestion and eliminate hot gas impingement on the disk post.

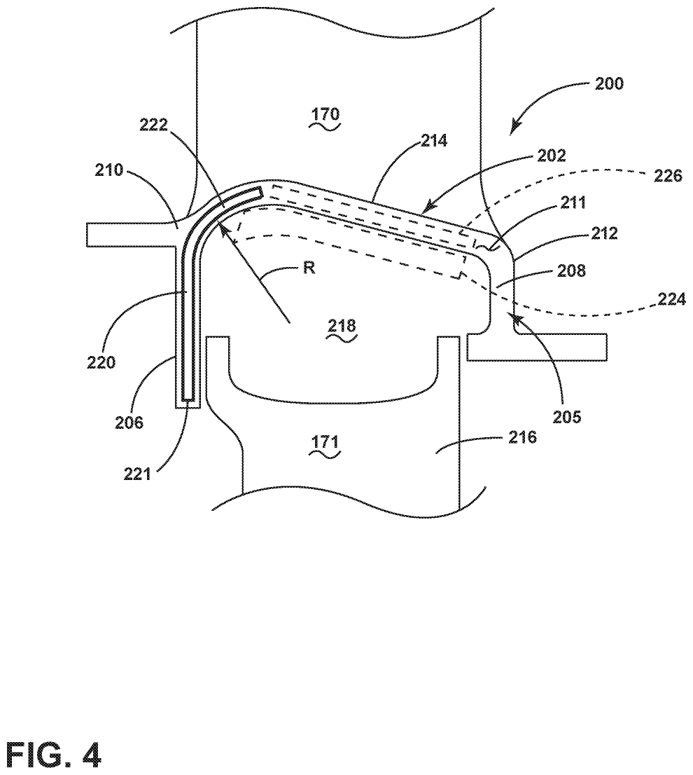

Turning to FIG. 4, another spline seal 220 is illustrated. The spline seal 220 is similar to the blocking spline seal 120, therefore, like parts will be identified with like numerals increased by 100, with it being understood that the description of the like parts of the blocking spline seal 120 applies to the spline seal 220, unless otherwise noted. The spline seal 220 includes a curved portion 222 defined by a radius (R) larger than the radius (R) of the blocking spline seal 120 already described herein.

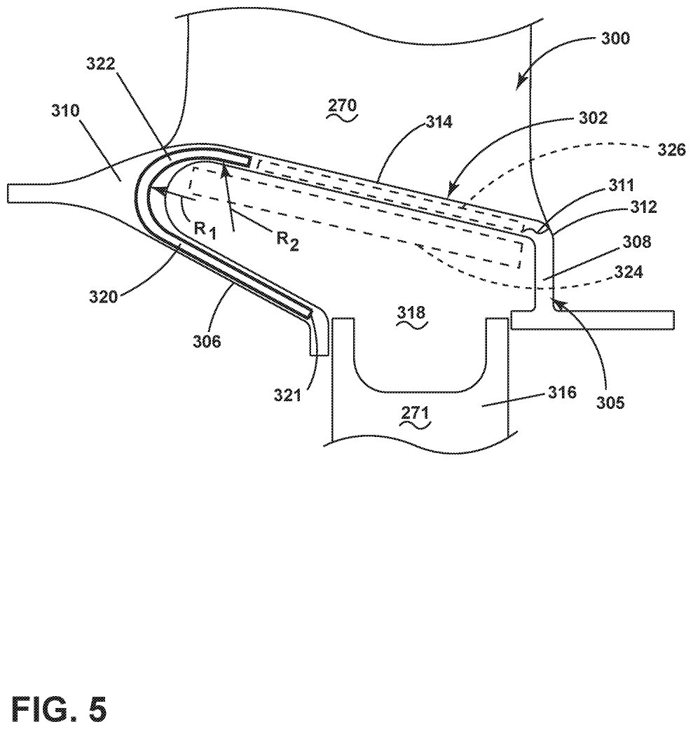

FIG. 5 is another spline seal 320. The spline seal 320 is similar to the blocking spline seal 120, therefore, like parts will be identified with like numerals increased by 200, with it being understood that the description of the like parts of the blocking spline seal 120 applies to the spline seal 320, unless otherwise noted. The spline seal 320 includes a curved feature 322 defining varying radii (RB) and (R2).

It should be understood that the spline seals 120, 220, 320 as described herein can be located in platforms having varying geometries and that the curved feature 122, 222, 322 as described herein can be formed to conform to those geometrical features.

Benefits associated with the spline seal as described herein and more particularly with the curved feature and the axial overlap between the forward spline and the blade damper seal include minimizing or dissipating hot gas ingestion and the prevention of hot gas impingement on a disk post. The overlap between the curved spline and the blade damper seal prevent direct line-of-sight between the hot gas ingestion flow path and the disk post—thus eliminating any direct impingement of hot gas onto the disk post. This increases the lifespan of the disk post as well as increases efficiency of the engine by channeling the hot gas ingestion flow path correctly.

To the extent not already described, the different features and structures of the various embodiments can be used in combination, or in substitution with each other as desired. That one feature is not illustrated in all of the embodiments is not meant to be construed that it cannot be so illustrated, but is done for brevity of description. Thus, the various features of the different embodiments can be mixed and matched as desired to form new embodiments, whether or not the new embodiments are expressly described. All combinations or permutations of features described herein are covered by this disclosure.

This written description uses examples to describe aspects of the disclosure described herein, including the best mode, and also to enable any person skilled in the art to practice aspects of the disclosure, including making and using any devices or systems and performing any incorporated methods.

Further aspects of the invention are provided by the subject matter of the following clauses:

1. An airfoil assembly for an engine comprising: a plurality of circumferentially arranged platforms having confronting end faces each platform defining a base portion from which an airfoil extends outwardly defining a radial direction and from which a set of legs extends radially inward; a disk post coupled to at least one leg of the set of legs; a cavity formed by the platform, set of legs, and the disk post defining a static pressure zone during operation; a high pressure zone located exteriorly of the cavity; and at least one blocking spline seal located within the confronting end faces and extending from the base portion to the set of legs across a direct path between the high pressure zone and the static pressure zone.

2. The airfoil assembly of any preceding clause, wherein the confronting end faces include confronting seal channels in which the at least one blocking spline seal is received.

3. The airfoil assembly of any preceding clause, wherein the confronting seal channels include an axial portion located in the base of the platform and a radial portion located in the at least one leg.

4. The airfoil assembly of any preceding clause, wherein the axial portion extends along a full width of the platform.

5. The airfoil assembly of any preceding clause, further comprising an axial spline seal extending axially within the confronting seal channels located in the base portion.

6. The airfoil assembly of any preceding clause, wherein the axial spline seal is axially spaced from the blocking spline seal.

7. The airfoil assembly of any preceding clause, wherein the at least one blocking spline seal further comprises a transition portion between an axial portion of the at least one blocking spline seal and a radial portion of the at least one blocking spline seal.

8. The airfoil assembly of any preceding clause, wherein the direct path is the shortest at the transition portion.

9. The airfoil assembly of any preceding clause, wherein the transition portion is a curved portion.

10. The airfoil assembly of any preceding clause, wherein the curved portion defines a constant radius.

11. The airfoil assembly of any preceding clause, wherein the curved portion defines varying radii.

12. The airfoil assembly of any preceding clause, further comprising a damper seal located within the static pressure zone radially inward from the base portion of the platform.

13. The airfoil assembly of any preceding clause, wherein the blocking spline seal overlaps with the damper seal.

14. A method of blocking a hot gas ingestion flow path between a high pressure zone located exteriorly of a platform for an airfoil assembly of an engine and a static pressure zone defined by a cavity formed radially inward of the platform, the method comprising: extending a blocking spline seal across the hot ingestion flow path where a portion of the blocking spline seal extends radially along a set of legs of the platform and a portion of the blocking spline seal extends axially along a base portion of the platform.

15. The method of any preceding clause, further comprising receiving the blocking spline seal in a confronting seal channel located in a confronting end face of the platform.

16. The method of any preceding clause, further extending axially an axial spline seal within the confronting seal channels located in the base portion.

17. The method of any preceding clause, further comprising extending an axial portion of the blocking spine along a full width of the platform.

18. The method of any preceding clause, further locating the blocking spline seal where a shortest path from the high pressure zone to the static pressure zone exists.

19. The method of any preceding clause, further comprising extending a damper seal axially within the static pressure zone radially inward from the base portion of the platform.

20. The method of any preceding clause, further comprising overlapping the damper seal with the blocking seal.

What is claimed is:

1. An airfoil assembly for an engine comprising:
a plurality of circumferentially arranged platforms having confronting end faces each platform defining a base portion from which an airfoil extends outwardly defining a radial direction and from which a set of legs extends radially inward;
a disk post coupled to at least one leg of the set of legs;
a cavity formed by the platform, set of legs, and the disk post defining a static pressure zone during operation;
a high pressure zone located exteriorly of the cavity; and
at least one blocking spline seal located within the confronting end faces and extending from the base portion to the set of legs across a direct path between the high pressure zone and the static pressure zone.

2. The airfoil assembly of claim 1, wherein the confronting end faces include confronting seal channels in which the at least one blocking spline seal is received.

3. The airfoil assembly of claim 2, wherein the confronting seal channels include an axial portion located in the base of the platform and a radial portion located in the at least one leg.

4. The airfoil assembly of claim 3, wherein the axial portion extends along a full width of the platform.

5. The airfoil assembly of claim 2, further comprising an axial spline seal extending axially within the confronting seal channels located in the base portion.

6. The airfoil assembly of claim 5, wherein the axial spline seal is axially spaced from the blocking spline seal.

7. The airfoil assembly of claim 1, wherein the at least one blocking spline seal further comprises a transition portion between an axial portion of the at least one blocking spline seal and a radial portion of the at least one blocking spline seal.

8. The airfoil assembly of claim 7, wherein the direct path is the shortest at the transition portion.

9. The airfoil assembly of claim 8, wherein the transition portion is a curved portion.

10. The airfoil assembly of claim 9, wherein the curved portion defines a constant radius.

11. The airfoil assembly of claim 9, wherein the curved portion defines varying radii.

12. The airfoil assembly of claim 1, further comprising a damper seal located within the static pressure zone radially inward from the base portion of the platform.

13. The airfoil assembly of claim 12, wherein the blocking spline seal overlaps with the damper seal.

14. A method of blocking a hot gas ingestion flow path between a high pressure zone located exteriorly of a platform for an airfoil assembly of an engine and a static pressure zone defined by a cavity formed radially inward of the platform, the method comprising: extending a blocking spline seal across the hot ingestion flow path where a portion of the blocking spline seal extends radially along a set of legs of the platform and a portion of the blocking spline seal extends axially along a base portion of the platform.

15. The method of claim 14, further comprising receiving the blocking spline seal in a confronting seal channel located in a confronting end face of the platform.

16. The method of claim 15, further extending axially an axial spline seal within the confronting seal channels located in the base portion.

17. The method of claim 14, further comprising extending an axial portion of the blocking spine along a full width of the platform.

18. The method of claim 14, further locating the blocking spline seal where a shortest path from the high pressure zone to the static pressure zone exists.

19. The method of claim 14, further comprising extending a damper seal axially within the static pressure zone radially inward from the base portion of the platform.

20. The method of claim 19, further comprising overlapping the damper seal with the blocking seal.
